(19) United States
(12) Patent Application Publication
(10) Pub. No.: US 2023/0143507 A1
(43) Pub. Date: May 11, 2023

(54) PROTECTION AGAINST FRONT-RUNNING ATTACKS IN CRYPTOGRAPHIC TOKEN SYSTEM

(71) Applicant: Robert Bosch GmbH, Stuttgart (DE)

(72) Inventor: Alexander Poddey, Wiernsheim (DE)

(21) Appl. No.: 18/050,545

(22) Filed: Oct. 28, 2022

(30) Foreign Application Priority Data
Nov. 9, 2021 (DE) 10 2021 212 598.0

(51) Int. Cl. G06Q 20/36

(52) U.S. Cl. CPC G06Q 20/3676; G06Q 2220/00

(57) ABSTRACT

A computer-implemented method for maintaining crypto tokens of a first type. A creation and annulment procedure are implemented that may integrate a bonding curve and a fee term starting from the current supply size to a new supply size to determine an amount of crypto tokens of a second type. The crypto tokens of the second type may be transferred to or from a pool, while crypto tokens of the first type may be transferred to a user or may be destroyed. The fee term may comprise the bonding curve shifted over an amount.

### CROSS REFERENCE

The present application claims the benefit under 35 U.S.C. § 119 of German Patent Application No. DE 10 2021 212 598.0 filed on Nov. 9, 2021, which is expressly incorporated herein by reference in its entirety.

### FIELD

The present invention relates to a computer-implemented method for maintaining crypto tokens of a first type, a server device, a client device, and a computer readable medium.

### BACKGROUND INFORMATION

A decentralized transaction system, transaction database or distributed ledger is any protocol in computer networks that brings about consensus regarding its transactions and their sequence. A common form of such a system is based on a blockchain and forms the basis of many so-called cryptocurrencies. In a cryptocurrency, cryptographic tokens are distributed across multiple clients. The clients can transfer the tokens among each other, or to and from a market maker. Cryptography and distributed ledger systems ensure that a transfer cannot easily be forged or repudiated.

Having a secure transfer system allows tokens of a first type to be exchanged for tokens of a second type. Colloquially, a token of the first type is bought, and has a price as an amount of tokens of the second type. Advanced cryptocurrencies use a mechanism known as “curved bonding”, according to which a function known as a bonding curve is algorithmically defined, which influences the price of units (tokens) of the currency depending on the current supply of tokens.

A conventional method for managing a cryptocurrency with “curved bonding” is described in PCT Patent Application No. WO 2019/043668 A1. In the conventional method, a plurality of users are provided with an in-marketplace wallet, suitable for storing linked digital tokens that are linked in value to cryptocurrency tokens and that are required to transact on a digital marketplace platform. A cryptocurrency reserve is provided suitable for storing a plurality of cryptocurrency tokens. In response to a user purchasing linked digital tokens from a marketplace store, linked digital tokens are transferred to the in-marketplace wallet of the user and an equivalent value of cryptocurrency tokens are transferred to the cryptocurrency reserve. In response to a user withdrawing a number of linked digital tokens from the in-marketplace wallet of the user, the desired number of linked digital tokens is removed from the user's in-marketplace wallet and an equivalent value of cryptocurrency tokens is transferred from the cryptocurrency reserve to an out-of-marketplace wallet of the user, the out-of-marketplace wallet suitable for storing cryptocurrency tokens outside of the marketplace platform.

FIG. 10 of the PCT patent application shows a graph illustrating how bonding of tokens may be applied. Token bonding is used to introduce a hierarchy of tokens which are fundamentally related to each other. Token bonding is a means of token generation with a predefined price-supply relationship or curve. This may be achieved through a smart contract: users deposit a reserve currency into the smart contract address, and in turn receive newly-minted tokens. The deposit may be locked up, to be returned to sellers of the token at a later date. The price the user pays per token may be dictated by the aforementioned curve. At any point, users may be able to exchange their minted tokens for the original reserve currency at a price dictated by the same curve. Sell and buy curves may be distinct.

For an additional x tokens to be purchased, the smart contract may look up the appropriate point on the curve based on existing circulating supply and determine the amount to be paid in the native token for the bundle of x tokens to be generated. A similar process may be provided for selling tokens which destroys these tokens by removing them from circulation and moving the total token supply backward along the bonding curve. Since the token may be 100% collateralized, the system may provide enough reserve currency stored to compensate the sold tokens. The bonding curve is defined in the conventional system as

$$f ( x ) = \frac{x}{c ( a + {x}^{b} )} , where a > 0 and 0.5 < b < 1 ; c > 1$$

### SUMMARY

The conventional system is vulnerable to front-running attacks. A front-running attack exploits the technical properties of the system for its own purposes.

By front-running a buy or sell transaction, miners and other actors might extract value from normal participants. Two classes of front-running can be distinguished: on the one hand, there are short-termed to medium-termed or high-frequency front-running (hffr)—where the normal transactions are not substantially delayed, but an attack transaction is placed ahead and right after of the normal transaction(s) in the execution queue. For example, a miner may collude and place a transaction in the front of the queue. For example, a user with knowledge of an upcoming large transaction may associate a high transaction fee with his front-running transaction to induce the miner to prioritize his transaction. A miner is an electronic device typically in the form of a server device configured as a miner.

Collusion among a partition of the miners, may delay certain transactions for a longer time-frame, referred to as active censorship. The corresponding attack is referred to as censorship based front-running (cfr). An example would be placing a buy transaction, then blocking all sell transactions and only allow buy transactions, finally selling and hence extracting the value before processing the delayed sell transactions.

Front-running attacks fall in a similar category as cryptographic attacks, denial of service, and the like. The technical properties of the system are exploited to serve the purposes of the attacker. Although non-technical solutions could be envisaged, e.g., imposing legislation that forbids front-running, a technical solution to the problem is preferred. The inventor realized that technical measures are indeed possible to mitigate these types of attacks.

Front-running attacks can be mitigated by introducing a buy/sell spread. If the annulling tokens gives fewer tokens back than creating those tokens costs, then the front-running attack becomes less efficient. A bonding curve is however often not linear, so that the desired amount of spread is not a constant, or a constant part of the creation/annulling volume. It was an insight of the inventors, that this can be avoided by making the spread, e.g., in the form of a fee that is incurred when creation of annulling of cryptographic tokens is requested. The inventor found however that this can be resolved by making the fee dependent on the bonding curve itself.

In an example embodiment of the present invention, cryptographic tokens of a first type are maintained by a smart contract. Smart contracts are an advantageous way to create a new cryptocurrency on distributed ledgers that support smart contracts. A smart contract is not necessary though. For example, a market maker implementing the same procedures as the smart contract could be part of the chain logic, e.g., of the chain-application layer. A user can call the procedures as if they were a smart contract defined on the ledger, even though the smart contract is implemented elsewhere. Embodiments using a smart contract can be converted to an embodiment without a smart contract by incorporating the functions of the smart contract into the chain logic, e.g., the software that runs the distributed ledger.

The first type tokens can be created or annulled in exchange for tokens of a second type. The second type tokens may be an established cryptocurrency, e.g., bitcoin, ether, etc. For example, the smart contract may implement a creation procedure for creating crypto tokens of the first type in exchange for crypto tokens of the second type and an annulling procedure for annulling crypto tokens of the first type in exchange for crypto tokens of the second type. The smart contract can also maintain information relating concerning the first type tokens, in particular, a current supply size indicating a current number of crypto tokens of the first type and a bonding curve defining a function.

For example, the amount of crypto tokens of the second type for the exchange may be computed by integrating a function from the current supply size to a new supply size. The function being a sum of the bonding curve and a number of further terms, for at least one of the creation and annulling procedures the further terms including a fee term comprising a multiple of the bonding curve shifted over an amount of crypto tokens of the first type.

For example, in case the creation procedure is triggered, the integration may be done over a creation function, while for annulment an annulment function may be used. Both functions may be equal to the bonding curve plus additional terms. The bonding curve is typically the principal term and ensures the long term development of the token. A fee term can be introduced which makes creation more expensive than it ought to be if only the bonding curve were taken into account, while annulling will obtain fewer tokens in return than the bonding curve alone would suggest. The fee terms thus makes a creation/annulment cycle unattractive. However, if the supply size is at a region where the bonding curve is mostly flat, only a small fee is needed to assure this, while if the bonding curve is steep larger fees are needed to make front running unattractive.

Interestingly, this can be achieved by making the fee term proportional to the local increase of the bonding curve. For example, the creation and annulment functions may be linear combinations of, e.g., the bonding curve and shifted versions of the bonding curve. In an embodiment, the fee term is indicative of the flatness of the bonding curve at that point.

An aspect of the present invention is a server device for maintaining crypto tokens of a first type. For example, the server device may be a so-called miner. An aspect of the present invention is a client device. For example, the client device may be used by a user, e.g., to initiate creation or annulment requests.

A further aspect of the present invention is a method for maintaining crypto tokens of the first type. An example embodiment of the method of the present invention may be implemented on a computer as a computer implemented method, or in dedicated hardware, or in a combination of both. Executable code for an embodiment of the method may be stored on a computer program product. Examples of computer program products include memory devices, optical storage devices, integrated circuits, servers, online software, etc. Preferably, the computer program product comprises non-transitory program code stored on a computer readable medium for performing an embodiment of the method when said program product is executed on a computer.

In an example embodiment of the present invention, the computer program comprises computer program code adapted to perform all or part of the steps of an embodiment of the method when the computer program is run on a computer. Preferably, the computer program is embodied on a computer readable medium.

Another aspect of the present invention is a method of making the computer program available for downloading.

### BRIEF DESCRIPTION OF THE DRAWINGS

Further details, aspects, and example embodiments of the present invention will be described, by way of example only, with reference to the figures. Elements in the figures are illustrated for simplicity and clarity and have not necessarily been drawn to scale. In the figures, elements which correspond to elements already described may have the same reference numerals.

FIG. 1A schematically shows an example of an embodiment of a client device, according to the present invention.

FIG. 1B schematically shows an example of an embodiment of a server device, according to the present invention.

FIG. 1C schematically shows an example of an embodiment of a cryptographic token system, according to the present invention.

FIG. 2 schematically shows an example of an embodiment of a blockchain, according to the present invention.

FIG. 3A schematically shows an example of an embodiment of a bonding curve, according to the present invention.

FIG. 3B schematically shows an example of an embodiment of a bonding curve, according to the present invention.

FIG. 3C schematically shows an example of an embodiment of a bonding curve, according to the present invention.

FIG. 3D schematically shows an example of an embodiment of a bonding curve, according to the present invention.

FIG. 4A schematically shows an example of an embodiment of updating a bonding curve, according to the present invention.

FIG. 4B schematically shows an example of an embodiment of a bonding curve, according to the present invention.

FIG. 4C schematically shows an example of an embodiment of a bonding curve, according to the present invention.

FIG. 4D schematically shows an example of an embodiment of a bonding curve, according to the present invention.

FIG. 5 schematically shows an example of an embodiment of a method for maintaining crypto tokens of a first type, according to the present invention.

FIG. 6 schematically shows an example of an embodiment of a method for maintaining crypto tokens of a first type, according to the present invention.

FIG. 7A schematically shows a computer readable medium having a writable part comprising a computer program according to an embodiment of the present invention.

FIG. 7B schematically shows a representation of a processor system according to an embodiment of the present invention.

### REFERENCE SIGNS LIST

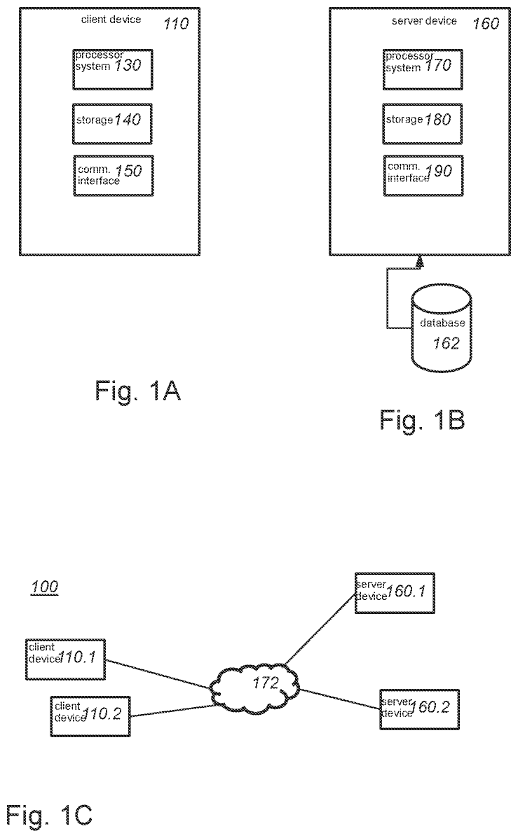

The following list of references and abbreviations corresponds to FIGS. 1a-4, 7a, 7b, and is provided for facilitating the interpretation of the figures and shall not be construed as limiting the present invention.
100 a crypto token system
110, 110.1, 110.2 a client device
130 a processor system
140 a storage
150 a communication interface
160, 160.1, 160.2 a server device
162 a database
170 a processor system
180 a storage
190 a communication interface
172 a computer network
210 a blockchain
211-215 a block
220 a smart contract
221 a create procedure
222 an annulment procedure
223 an update procedure
231-234 a state
241-242 a crypto token transfer
251-253 a point in time
301 a bonding curve
311 an amount of crypto tokens of the first type
312 an amount of crypto tokens of the second type
313 an amount of crypto tokens of the second type
314 an amount of crypto tokens of the second type
X1, X2 an amount of crypto tokens of the first type
315 current supply of crypto tokens of the first
type
330 state information
321-323 curve segment parameters
324-326 curve segment parameters
341 a bonding curve increase
342 a point on the bonding curve
343 a shifted point on the bonding curve
1000, 1001 a computer readable medium
1010 a writable part
1020 a computer program
1110 integrated circuit(s)
1120 a processing unit
1122 a memory
1124 a dedicated integrated circuit
1126 a communication element
1130 an interconnect
1140 a processor system

### DETAILED DESCRIPTION OF EXAMPLE EMBODIMENTS

While the presently disclosed subject matter is susceptible of embodiment in many different forms, there are shown in the figures and will herein be described in detail one or more specific embodiments, with the understanding that the present disclosure is to be considered as exemplary of the principles of the presently disclosed subject matter and not intended to limit it to the specific embodiments shown and described.

In the following, for the sake of understanding, elements of embodiments are described in operation. However, it will be apparent that the respective elements are arranged to perform the functions, e.g., procedures, being described as performed by them.

Further, the subject matter that is presently disclosed is not limited to the embodiments only, but also includes every other combination of features disclosed herein.

FIG. 1A schematically shows an example of an embodiment of a client device 110. FIG. 1B schematically shows an example of an embodiment of a server device 160.

For example, server device 160 may be configured to maintain crypto tokens of a first type. For example, server device 160 may be configured to receive a creation request for creating tokens of the first type, or an annulment request for annulling tokens of the first type, or an update request to update a bonding curve. In response, server device 160 may include data reflecting the transaction(s) in a new block for the blockchain. The information may reflect the transaction, showing that a user obtained the tokens or that the tokens were removed from the user, or state information of the contract, e.g., including a new bonding curve definition or a new current supply, etc. The server device is sometimes referred to as a miner, or mining device, or as a minter, or minting device.

Server device 160 may be configured to obtain a smart contract from a distributed ledger, e.g., a blockchain. The smart contract may implement a creation procedure to fulfill creation requests, an annulment procedure to fulfill annulment requests and so on. Server 160 may be configured to execute the corresponding computer code in the smart contract. Instead of a smart contract the procedures may be implemented in conventional software, e.g., in so-called chain logic. The data maintained by the software may be written on the distributed ledger in both cases. For example, a transaction showing the creation or annulment of a token may be put on the distributed ledger, an updated supply size, bonding curve and the like may be put on the distributed ledger.

For example, client device 110 may be configured to maintain a wallet. For example, the client device 110 may be configured to send a request to server device 160 for tokens of the first type, or to annul tokens of the first type, etc. Client device 110 may also send an update request to update the bonding curve. For example, it may be required that an update request is linked to a particular identity, e.g., signed by a particular private key.

Client device 110 may comprise a processor system 130, a storage 140, and a communication interface 150. Server device 160 may comprise a processor system 160, a storage 180, and a communication interface 190. Storage 140 and 180 may be electronic storage. The storage may comprise local storage, e.g., a local hard drive or electronic memory. Storage 140 and 180 may comprise non-local storage, e.g., cloud storage. In the latter case, storage 140 and 180 may comprise a storage interface to the non-local storage.

Client device 110 and server device 160 may be part of a crypto token system, e.g., crypto token system 100. Client device 110 and server device 160 may communicate internally, with other systems, external storage, input devices, output devices, and/or one or more sensors over a computer network. The computer network may be an internet, an intranet, a LAN, a WLAN, etc. The computer network may be the Internet. The system comprises a connection interface which is arranged to communicate within the system or outside of the system as needed. For example, the connection interface may comprise a connector, e.g., a wired connector, e.g., an Ethernet connector, an optical connector, etc., or a wireless connector, e.g., an antenna, e.g., a Wi-Fi, 4G or 5G antenna.

The communication interface 150 may be used to send or receive digital data, e.g., request to create or annul cryptographic tokens. The communication interface 190 may be used to send or receive digital data, e.g., request to create or annul cryptographic tokens. The communication interface 190 may be used to communicate with other server devices, e.g., to distribute a new block of a blockchain.

The execution of devices 110 and 160 may be implemented in a processor system, e.g., one or more processor circuits, e.g., microprocessors, examples of which are shown herein. The processor system may comprise one or more GPUs and/or CPUs. Devices 110 and 160 System 100 may comprise multiple processors, which may be distributed over different locations. For example, devices 110 and 160 may use cloud computing.

The devices 110 and 160 may comprise functional units that may be functional units of the processor system. For example, the functional units shown may be wholly or partially implemented in computer instructions that are stored at the device, e.g., in an electronic memory of the device, and are executable by a microprocessor of the device. In hybrid embodiments, functional units are implemented partially in hardware, e.g., as coprocessors, e.g., cryptographic coprocessors, and partially in software stored and executed on the device.

FIG. 1C schematically shows an example of an embodiment of a cryptographic token system. System 100 comprises multiple client devices; shown are client device 110.1 and 110.2. System 100 comprises multiple server devices; shown are server device 160.1 and 160.2. The devices are connected through a computer network 172, e.g., the Internet. The client and server device may be according to an embodiment. The client devices may cooperate among each other to transfer cryptographic tokens of the first type. The client devices may interact with a server device to create or to annul a cryptographic token of the first type, e.g., in exchange for cryptographic tokens of the second type.

Storage may be implemented as an electronic memory, say a flash memory, or magnetic memory, say hard disk or the like. Storage may comprise multiple discrete memories together making up storage 140, 180. Storage may comprise a temporary memory, say a RAM. The storage may be cloud storage.

Typically, the client device 110 and server device 160 each comprise a microprocessor which executes appropriate software stored at the system; for example, that software may have been downloaded and/or stored in a corresponding memory, e.g., a volatile memory such as RAM or a non-volatile memory such as Flash. Alternatively, the systems may, in whole or in part, be implemented in programmable logic, e.g., as field-programmable gate array (FPGA). The systems may be implemented, in whole or in part, as a so-called application-specific integrated circuit (ASIC), e.g., an integrated circuit (IC) customized for their particular use. For example, the circuits may be implemented in CMOS, e.g., using a hardware description language such as Verilog, VHDL, etc. In particular, client device 110 and server device 160 may comprise circuits for the cryptographic processing, and/or arithmetic processing.

A processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only.

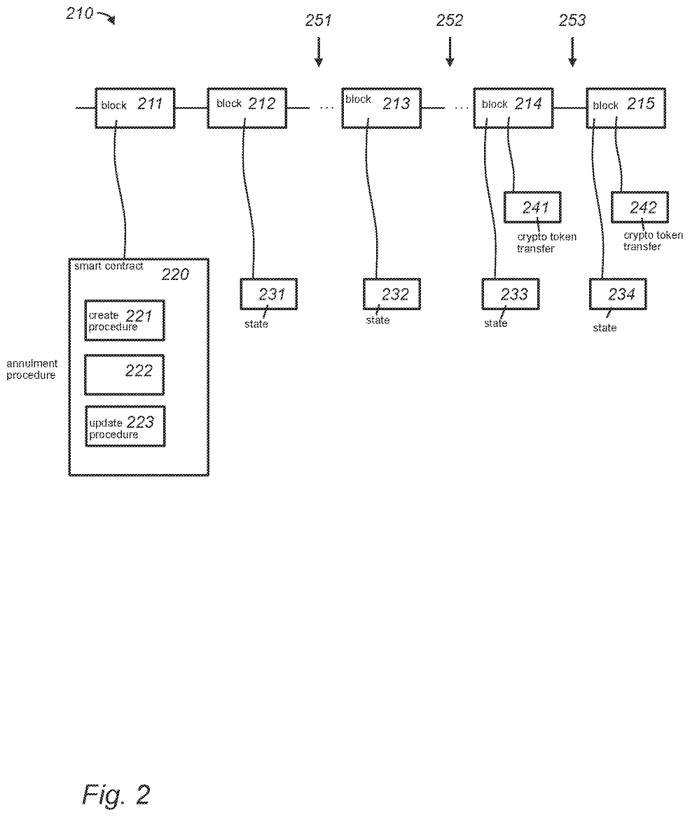

FIG. 2 schematically shows an example of an embodiment of a blockchain 210. Blockchains are particular example of distributed ledgers that has shown to work well in embodiments. Other examples of distributed ledgers can also be used. For example, in an embodiment the distributed ledger may be a hash graph, a tangle or a lattice. The distributed ledger comprises multiple blocks, which are linked to each other. The blocks may comprise transactional data and metadata. The metadata may comprise linking information and a consensus mechanism. Embodiments are primarily described with reference to a blockchain, but such an embodiment could be changed to use another type of distributed ledger, in particular a graph based one.

Blockchain 210 comprises multiple blocks, which are linked to each other in a sequence. For example, the linkage may comprise a consensus mechanism. For example, such a mechanism may be a proof of work, e.g., as in Bitcoin. The mechanism may be a proof of stake. A consensus mechanism allows distributed trust in the distributed ledger. Other consensus mechanism, e.g., as known in the art may be used in an embodiment.

To aid the discussion, FIG. 2 shows three points in the blockchain: points 251, 252, and 253, corresponding to three moments in time. At point 251, blocks up to block 213 have been created, but not yet block 213. At point 252, blocks up to block 214 have been created, but not yet block 214. At point 253, blocks up to block 215 have been created, but not yet block 215.

Show in blockchain 210 are multiple blocks, in this case, 5 blocks: blocks 211, 212, 213, 214, and 215. There may be more or fewer blocks. A block may comprise data related to the distributed ledger mechanism, e.g., consensus data, but also other information. In particular a block may comprise transactions, in which tokens are bound to an address, e.g., related to the public key of a client, e.g., as incorporated in a client device. Blocks may also include other information.

In particular, a block may comprise a smart contract. Block 211 shows an example, in the form of a smart contract 220. A smart contract is typically written in a computer language. An example of a computer language that is optimized for smart contracts is solidity. For example, in an embodiment blockchain 210 may be the Ethereum blockchain, and the smart contract may be written in solidity. It is not required to restrict to a particular language or blockchain though. For example, the Ethereum blockchain may be used as described in the paper “Ethereum: a secure decentralised generalised transaction ledger”, by G. Wood, e.g., the Istanbul version 80085f7 of Jul. 11, 2021.

For example, in an embodiment, a server configured to maintain crypto tokens of a first type may be configured to obtain the smart contract from the distributed ledger. For example, the smart contract may be stored in a block of the distributed ledger. The smart contract may implement the needed procedures, e.g., a creation procedure for creating the crypto tokens of the first type and an annulment procedure for the annulment of crypto tokens of the first type. The smart contract may also implement an update procedure. The smart contract may be configured to maintain the current supply size. The smart contract may define the bonding curve.

In an embodiment, blockchain 210 is used to create and annul cryptographic tokens of a first type. Colloquially, creating new cryptographic tokens is sometimes referred to a ‘buying’ the tokens; annulling a cryptographic token is sometimes referred to as ‘selling’ the tokens.

The smart contract implements multiple procedures, including at least a create procedure 221 and an annulment 222 (also called a sell procedure). Optionally, the contract may implement an update procedure 223. Colloquially, the create procedure is also called a buy procedure and the annulment procedure 222 a sell procedure.

This is not entirely accurate as typically the tokens no longer exist once they are annulled. The total supply of tokens decreases after an annulment action. The annulment procedure is also referred to as a destroy procedure.

The server executes the create procedure and as a result obtains a new state. For example, the new state may reflect the increased number of crypto tokens of the first type that are now in existence (referred to as the supply). The server may also obtain a transaction that indicates that the new cryptographic tokens are transferred to the first user, and/or a transaction that indicates that the existing cryptographic tokens of the second type are transferred from the first user to a wallet associated with the smart contract. The smart contract is referred to as the market maker. An amount of second type tokens may be kept in reserve by the market maker, e.g., in wallet. This part of the wallet is referred to as the pool or pool balance. The same wallet may be used to hold tokens not part of the pool. One may also reserve use of this wallet for only the pool.

The server client writes on the blockchain, e.g., includes in a block, the new state, and the new crypto tokens of the first type, the transferred crypto tokens of the second type are written on this or another blockchain. Tokens of the first type and the state may be put on separate blockchains as well.

Suppose a first user wants to buy a number of crypto tokens of a first type. He/she sends a request through a client device to a server device. The request may be sent to multiple server devices. The request may include, e.g.,
the amount x crypto tokens of a first type requested
instructions to transfer y crypto tokens of a second type
an address to bind the crypto tokens of a first type to.

For example, consider that the request is sent at point 252, just before clock 214 is created.

The server device retrieves the smart contract 220 from the blockchain. The smart contract uses a state which may be updated.

The server device retrieves the current state from the blockchain. Blockchain 210 shows states 231 and 232 before point 252, so that the server device retrieves state 232.

To determine the amount of cryptographic tokens of the second type (y) that are exchanged for an amount of cryptographic tokens of the first type (x), colloquially referred to as the price, the smart contract uses a bonding curve. The smart contract may comprise a definition of the bonding curve. The definition of the bonding curve may also be in a state. The definition of the bonding curve may be the smart contract, until a new definition in a written state overrides it. Note that a bonding curve is typically increasing or at least is non-decreasing.

In an embodiment, the smart contract is not stored in a block but is accessible to the server through other means; for example, the smart contract may be obtained before executing said procedures. Using a smart contract may have the advantage that a proof of execution, e.g., of any particular procedure, can be placed on the distributed ledger. Note that even if a smart contract is not placed on the chain, it can still be executed as one, provided other miners have access to its code.

In fact, the procedures need not even be implemented in a smart contract but may be implemented in conventional software. For example, such software may be obtained by the server before execution. The software may be part of the chain logic software that defined the mining operation.

In an embodiment, the market maker, e.g., the smart contract or other software, could be part of the chain-application layer. A user may call the procedures like in a smart contract.

If no smart contract is used, the wallet or pool associated with the smart contract may be replaced with a wallet or pool associated with the market maker, e.g., with the software that implements the cryptocurrency.

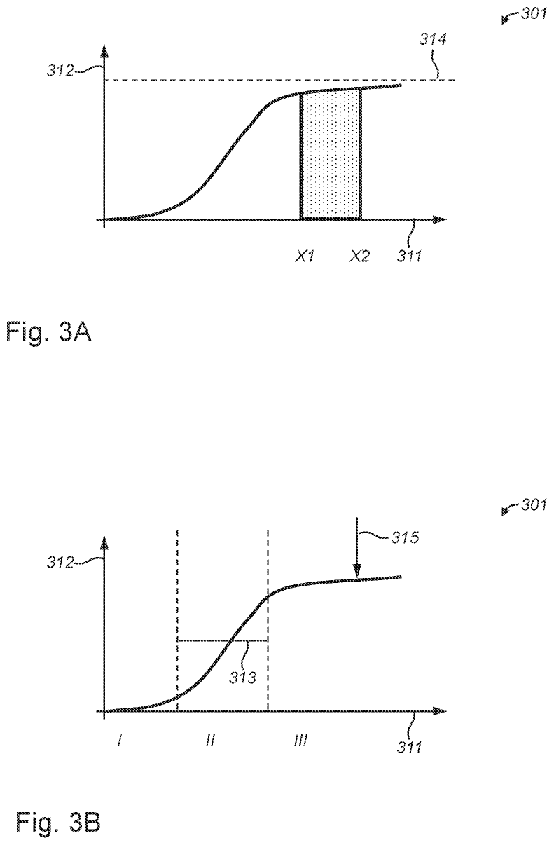

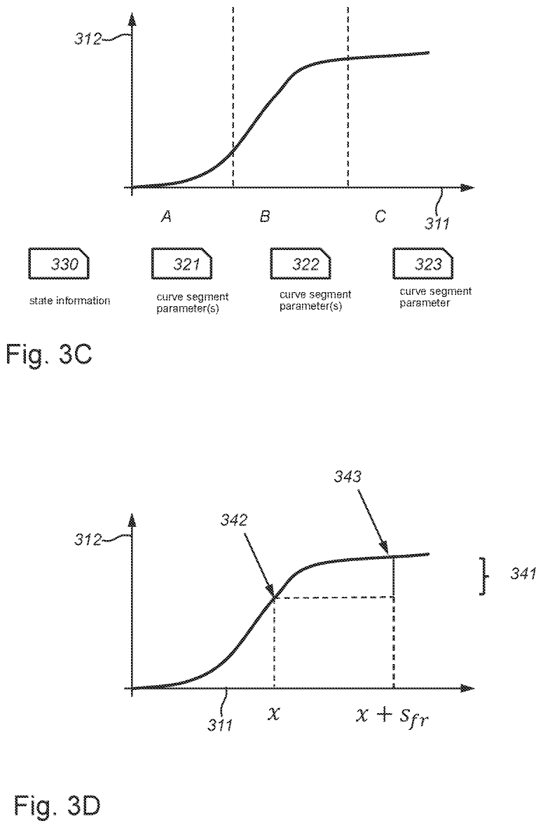

FIG. 3A schematically shows an example of an embodiment of a bonding curve 301. On the x-axis 311 is the amount of crypto tokens of the first type. On the y-axis 312 is the amount of crypto tokens of the second type.

Suppose the supply of tokens of the first type is currently X1, and the first user wants to obtain (X2−X1) tokens, so that the new supply will become X2. To determine the amount of tokens of the second type that are to be exchanged, one integrates a function from X1 to X2. In case of creating tokens, this function may be referred to as the creation function. Typically, a bonding curve is increasing or at least non-decreasing.

Likewise, suppose the supply of tokens of the first type is currently X2, and the first user wants to annul (X2−X1) tokens of the first type, so that the new supply will become X1. To determine the amount of tokens of the second type that are to be received, one integrates a function from X1 to X2. In case of annulling tokens, this function may be referred to as the annulling function.

In an embodiment, The function that is integrated, e.g., the creation function or the annulling function, can be represented as a sum of terms. The first term may be the bonding curve.

Typically, the bonding curve term is the major term, e.g., larger than the other terms.

In conventional systems, the function may be only the bonding curve, this would work in the sense that tokens of the first or second types can reliably be exchanged for tokens of the second of first type, but these systems are vulnerable to an attack known as front-running. If an attacker can influence the order in which orders are processed, or the order in which his order is processed relative to other orders, he/she can artificially ensure that the order receives a favorable treatment. These are known as front running attacks. To mitigate this risk, the function that is integrated can include, in addition to the bonding curve a fee term. The fee term makes front running less favorable, or even unfavorable.

In an embodiment, the fee term comprises a multiple of the bonding curve shifted over an amount of crypto tokens of the first type, e.g., s_{fr}. For example, if the bonding curve is Γ(x), then the shifted bonding curve may be Γ(x+s_{fr}) or Γ(x−s_{fr}). The fee term may also comprise the bonding curve is Γ(x) itself. For example, fee terms may be difference of such terms or a multiple thereof. That is fee term may be of the form γ(Γ(x+s_{fr})−Γ(x)), in which γ is a number, e.g., a real number, e.g., a number between 0 and 1, e.g., 0.5, or the like. The difference dl=Γ(x+s_{fr})−Γ(x) may also be weighted in other ways, e.g., with an exponent, dl^{γ}, or in a polynomial, P(dl) and so on. The difference term dl is representative for the flatness of the binding curve around x.

An advantage of including a term like γ(Γ(x+s_{fr})−Γ(x)) in a fee term, is that the fee term is small if the supply size is large. That is, if the system is mature and the bonding curve is quite flat, then only small gains can be made with frontrunning, but if the system is not yet mature and the bonding curve is steep then the fee is large and frontrunning is correspondingly less favorable.

FIG. 3A shows the bonding curve and the integration, in an embodiment, the integration is also over a fee term. In addition to the integration, a constant term may be added or subtracted to the amount of second type tokens that are transferred or received. The constant term is typically not integrated over, although it could be.

Note that X1 and X2 may be integral numbers, but this is not necessary. Tokens may also be created and annulled in fractions of integer tokens. A new state written to the ledger may include that the new supply of tokens is X2.

For example, tokens of the first type may be a new type of token created according to an embodiment, e.g., to facilitate some new applications that requires token management. This could range from shops, to games, to services, to dating applications. Tokens of the second type are typically existing tokens that can be transferred digitally. For example, the tokens of the second type may be bitcoin or ether, or the like.

The bonding curve is typically only used when creating or annulling tokens with respect to the market maker. The tokens of the first type could be transferred on a secondary market as well, and in theory the tokens may be exchanged for whatever the parties agree to. However, as both parties also have the option to obtain tokens from the market maker, or to have them annulled by the market maker, the bonding curve will have a strong influence on the secondary market. One motivation to use bonding curves is to avoid large price fluctuations.

The bonding curve may have an S-shape, or sigmoidal shape, e.g., as shown in FIG. 3A. When supply on the x-axis is low, the tokens can be obtained easily. When the market is mature, the price typically converges to a value 314. This is not needed, though. Instead of convergence, e.g., the price increase may be much flatter than in middle part of FIG. 3A. A sigmoidal shape is not necessary though. For example, a bonding curve may have a bend-up shape.

In an embodiment, the bonding curve is defined by multiple curve segments. The multiple segments are concatenated and together define the bonding curve. This has the advantage that different equations can be used for the different curve segments. If one function were used to define the entire curve, then this is would be complicated function to accommodate the desired shape of the curve. Such a complicated function is hard to integrate. On the other hand, when segments are used, one would integrate along the segment or segments that defines that part of the bonding curve.

The shape of a curve segment may be defined by parameters. For example, they may be defined by coefficients. For example, a curve segment may be a polynomial curve. For example, they may be polynomials of low degree, e.g., at most degree 5, at most degree 4, at most degree 3. In experiments, it was found that using three curve segments and polynomials of degree 3 (cubic polynomials) worked well; a bonding curve can be defined with fewer, e.g., 1 or 2, or more curve segments as well though.

In an embodiment, the create procedure and annulment procedure use the same bonding curve.

Accordingly, the create procedure 221 in smart contract 220 may be configured to
integrate the creating function from the current supply to the current supply+x to obtain the required amount of crypto tokens of the second type
Transfers the crypto tokens of the second type to a pool associated with the smart contract
Increases the current supply with x, and bind x crypto tokens of the first type to the address.

Accordingly, block 214 may comprise a new state 233, e.g., comprising the new supply, and transaction(s) 241.

An annulment procedure may work in reverse. For example, a request to annul x crypto tokens of the first type may be implemented by annulment procedure 222 as follows:
integrate the annulment function from the current supply −x to the current supply to obtain the required amount of crypto tokens of the second type
Transfers the crypto tokens of the second type from the pool associated with the smart contract to an address associated with the user.
Mark as invalid the x crypto tokens of the first type for the user.
Decrease the current supply with x

For example, if the annulment request is received at point 253, then block 215 may comprise a new state 234, e.g., comprising the new supply, and transaction(s) 242.

If no smart contract is used, the pool may be associated with the market maker.

The result of the create or annulment procedure may be one or two transactions for the tokens of the first and second type respectively, and a new state. These three items may be written on a blockchain, such as the blockchain 210.

Both the create and annulment procedure may refuse to perform the create or annulment task if preconditions are not met. For example, the amount of crypto tokens of the second type available for a create request should be large enough, e.g., at least as large as the integral indicates. For example, the amount of crypto tokens of the second type available in the pool for an annulment request should be large enough, e.g., at least as large as the integral indicates. The second condition can be enforced though by enforcing that the size of the pool is always equal to the size of the integral of the annulment function from 0 up to the current supply point.

Update procedure 223 may be called to change the shape of the bonding curve. Examples of update procedure 223 are given herein.

For completeness, FIG. 3B schematically shows an example of an embodiment of a bonding curve as may be used when the market is in its infancy. Shown are three phases, sometimes called regimes. In a first regime I, tokens of the first type are created. Although the bonding curve indicates that tokens of the second type should be exchanged for them, to fill a pool this is not done in regime I. For example, these tokens may be used as an incentive for early investors, inventors, and the like. In a second phase, or regime II, tokens of the first type are exchanged for tokens of the second type. However, instead of the price indicated by the bonding curve, a constant price 313 is used. The price is chosen such that at the end of regime II, the size of the pool (in tokens of the second type) is as large as the integral of the bonding curve up to the end of regime II. Regime II may for example, be used to start-up the system. For example, early investors may perform this task. In regime III, the prices follow the bonding curve as indicated above. Should the supply drop from regime III into the part of the curve for regime II or I, then the normal prices as indicated by the bonding curve are used. Various refinements are possible. For example, the system may refuse to annul tokens if that would cause the supply to drop between a certain amount. Two bonding curves may be used, etc.

In an embodiment, the market maker, e.g., in a state on the distributed ledger maintains a current supply of first type tokens. For example, FIG. 3B shows at 315 the current supply of tokens. If first type tokens are created, the amount of second type tokens needed for it is obtained by integrating the curve starting from point 315 to the right; that is toward higher supply as tokens are created. If first type tokens are annulled, the amount of second type tokens offered in return is obtained by integrating the curve starting from point 315 to the left; that is toward lower supply as tokens are destroyed.

A bonding curve may be defined by parameters. This has advantages, as it reduces the amount of data that needs to be stored on the ledger, e.g., in the smart contract or with an update of the bonding curve. A bonding curve may also be defined off-chain, e.g., in chain logic. Preferably, the integral of the bonding curve can be expressed in terms of the parameters, e.g., as a function taking the parameters as input. This reduces the amount of on-chain computation. For example, a bonding curve may be defined as one or more splines, line segments, polynomials, polynomial segments.

FIG. 3C schematically shows an example of an embodiment of a bonding curve. Shown in FIG. 3C are three curve segments: segments A, B and C. Using curve segments are a convenient way to encode a bonding curve in a smart contract and the like.

In each curve segment the bonding curve is defined by one or more parameters. For example, parameters 321 define segment A, parameters 322 define segment B, and parameters 323 define segment C. The parameters 321-323 may be included in the state, especially if the bonding curve is updatable. Also shown in FIG. 3C is supply 330, that is the amount of tokens of the first type that are currently in existing, e.g., the sum of successful creation requests minus the sum of successful annulment requests.

A convenient way to define the curve segments is to use polynomials. The parameters 321-323 may comprise the coefficients of the polynomials. The exponents in polynomials are integral. The curves may be defined by so-called generalized polynomials, e.g., sums of the terms of the form ax^{b}, wherein b may be non-integer, though, typically, rational. Generalized polynomials share with regular polynomials, that they can be integrated easily and in closed form. Polynomials can be conveniently expressed in the form of Bezier splines.

It is possible that the segments, e.g., segment A, B, and C, follow the same division as the regimes I, II and III, but this is not necessary. On the contrary, it was found that flexibility in choosing where segments start and end can allow a better fit. For example, segment A can be larger than regime I, while segment B, may be smaller than regime II. Regime III may start before segment C. Where the best points for starting and ending segments may depend on the fitting of the curves.

A fee term may also be expressed as a function, which may be defined similarly, e.g., using one or more curve segments defined by parameters, e.g., polynomial parameters. An advantage of expressing the fee term in terms of the bonding curve, e.g., as a linear combination of shift(s) of the bonding curve, is that no new set of parameters is needed, except possibly for the amount of shift. The shift may be predetermined, e.g., hard coded, e.g., part of the chain logic. The shift may be configurable, e.g., part of a state saved on the blockchain. This shift may be dynamic, e.g., determined from past transactions, e.g., past transaction as visible on the ledger.

FIG. 3D schematically shows an example of an embodiment of a bonding curve. Shown is a current amount x and the shifted amount x+s_{fr}. Value of the bonding curve at x is indicated at 342, e.g., Γ(x) and the value of the bonding curve at the shifted location is indicated at 343, e.g., Γ(x+s_{fr}). The difference is indicated at 341, e.g., Γ(x+s_{fr})−Γ(x). The fee term may comprise a multiple of said difference.

In an embodiment, a function is integrated from a current supply size to a new supply size to determine the amount of crypto tokens of the second type for the exchange. For example, for creation this may be a creation function; for annulling this may be an annulment function. The function may be a sum of the bonding curve and a fee. The amount may be the sum of the integration and a transaction costs. Typically, the transaction cost is positive for creation and negative for annulment. The integration may be done by a smart contract.

For example, the creation function may be the sum of the bonding curve and a fee term Γ(x)+σ_{p,b}; the annulment function may be the remainder of the bonding curve minus a fee term (Γ(x)−σ_{p,s}). The fee terms are typically chosen such that the resulting creation or annulment function remains positive. Either function may be integrated over the interval between the current supply and the new supply. The direction of integration may be taken such that the amount is positive.

The fee term may comprise a multiple of the bonding curve shifted over an amount of crypto tokens of the first type s_{fr}. The amount of crypto tokens s_{fr} may be chosen so that the amount of trading that an attacker is expected to be able to influence is smaller. For example, assuming new blocks are added to the ledger every few hours, one can choose the amount of tokens for shifting s_{fr} to be the expected number of crypto tokens of the first type involved in creation and/or annulment actions.

The fee term may be proportional to the increase of the bonding curve over an interval, in FIG. 3D this is amount 341. Note that the amount 341 changes with x as the integral is taken over an interval of x.

In FIG. 3D, the increase is equal to Γ(x+s_{fr})−Γ(x). The fee term may be equal to a multiple of this. In an embodiment the value of ½ is used. Other options are possible.

The amount of crypto tokens of the first type over which the bonding curve is shifted may be a constant. The constant may be fixed, e.g., in the smart contract. The constant may be updatable, e.g., an administrator may call a shift-constant update procedure in the smart contract. The shift-constant update procedure may be configured to receive a new constant, or may be configured to compute a new constant as indicated below. Calling the procedure may need a cryptographic token to be included in the call, e.g., a token authenticating the caller, e.g., a signature.

The amount over which the bonding curve is shifted may be computed dynamically as well. In particular, it may be computed from the ledger. For example, the smart contract, e.g., said update procedure, may be configured to compute the volume of created and/or annulled crypto tokens in a number of most recent blocks on the distributed ledger. The amount may be computed from the volume. For example, it may be some multiple of it. The amount may be equal to the volume. For example, the amount may be the volume over the past six hours, or may be half the volume over the past 12 hours, etc. The size of the ledger to take into account, may be expressed in time, but may also be expressed in blocks. For example, it is unlikely that an attack can influence transaction in more than n blocks, where n may be taken as small as 2 or 3. The volume can then be computed from cn blocks, where c is a safety parameter, which may be, say, 1 or 2. For example, in an embodiment, the amount shifted is the amount of tokens exchanged in creation an annulment transaction in the past 4 blocks on the ledger. If there are fewer than 4 blocks on the ledger the smart contract may use a default value for the amount.

Determining the shift amount s_{fr} may be done before each creation or annulment procedure, or periodically, e.g., daily, or every m transactions, e.g., every 100 transactions. Determining the shift amount may be triggered, e.g., by an outside call to an update procedure. Determining the shift amount may be triggered if conditions defined in the smart contract are met. For example, if some threshold is met; for example, if the number of transaction of first type tokens exceeds a threshold, or if the number of blocks on the ledger exceeds a threshold, etc.

In an embodiment, the creation function or an annulling function is derived from a bonding curve as a linear combination of one or more of the bonding curve (Γ(x)), a shifted bonding curve (Γ(x+s_{fr}); Γ(x−s_{fr})) and an optional constant. There may be multiple shifts, e.g., a linear combination of Γ(x), Γ(x+s₁), Γ(x+s₂) and 1.

An embodiment of a computer-implemented method for maintaining crypto tokens of a first type, comprises
obtaining a smart contract from a distributed ledger, the smart contract implementing a creation procedure for creating crypto tokens of the first type and an annulling procedure for annulling crypto tokens of the first type, the smart contract maintaining a current supply size indicating a current number of crypto tokens of the first type and a bonding curve defining a function,
in response to initiating the buy procedure, computing an amount of crypto tokens of the second type by integrating a creation function from the current supply size to the current supply plus a creating amount of crypto tokens of the first type, transferring the amount of crypto tokens of the second type to a pool associated with the smart contract, and increasing the current supply size with the amount of crypto tokens of the first type, and transferring the amount of crypto tokens of the first type, and
in response to initiating the buy procedure, computing an amount of crypto tokens of the first type by integrating an annulling function from the current supply size to the current supply minus an annulling amount of crypto tokens of the second type, transferring the amount of crypto tokens of the second type from the pool associated with the smart contract, and decreasing the current supply size with the amount of crypto tokens of the first type, and invalidating the amount of crypto tokens of the first type, wherein
at least one of
the buy function is a sum of the bonding curve and one or more further terms including a positive fee term, and
the sell function is a sum of the bonding curve and one or more further terms including a negative fee term, wherein
the fee term is a sum of at least one term comprising a multiple of the shifted bonding curve.

For example, the fee term may comprise a difference between the bonding curve and a shift of the bonding curve over a value s_{fr}

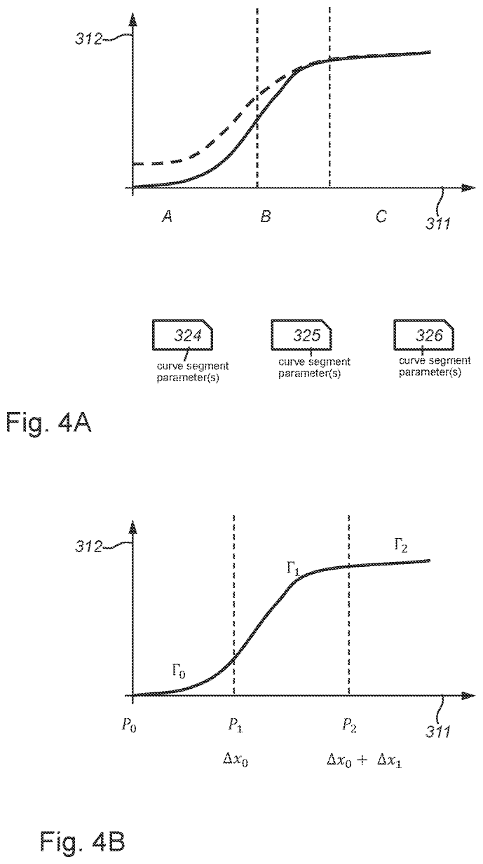

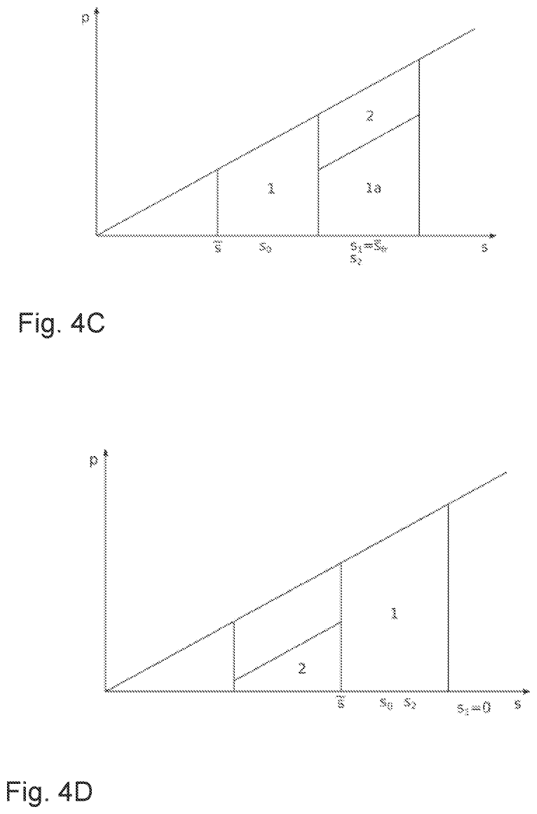

FIG. 4A schematically shows an example of an embodiment of updating a bonding curve. There can be several reasons why a bonding curve may need to be changed after the smart contract has been defined. A typical reason is that the amount of crypto tokens of the second type in the pool changed, and is not equal to the amount of crypto tokens indicated by the integral of the bonding curve.

For example, in a two bonding curve system, e.g., in which creation will gain the market maker more tokens than annulment costs, the market maker may gradually have more tokens of the second type available than the integral of the bonding curve represents.

The tokens of the second type that are accrued by a buy-sell spread may be collected by the market maker, e.g., in the same wallet as the pool, or in a separate wallet. If all or part of the additional tokens are added to the pool, the integral of the bonding curve may be lower than the new amount in the pool.

In a typical embodiment, the pool balance always reflects the integral value, at least once in operation and/or general trading, e.g., when in regime III. The update procedure may change the bonding curve such that the new integral indicates, e.g., equals, the new pool balance. For example, the marked maker may be constructed such that the integral value and pool balance can never be different; so that one only updates both together, accordingly.

The tokens of the second type that are accrued by a buy-sell spread may be collected by the market maker, e.g., in the same wallet as the pool. For example, the market maker may have a wallet, a subset of which holds the pool balance, which may exactly reflect the integral, e.g., after the system is in general operation. A second subset of the market maker's wallet could hold further value, e.g., an income generated by the market maker. In this case, the value of the wallet may be different from the integral and from the pool balance, though the latter two may be perfectly balanced. For example, changing the pool balance may be done by calling an update procedure which would adapt the pool balance and curve shape together, transferring value to or from the pool balance part of the wallet. The pool balance may be defined as the amount indicated by the integral of the bonding curve, e.g., the integral from supply zero to current supply. In an embodiment, it is guaranteed that the amount in the wallet is at least as high as the integral indicates.

The tokens of the second type that are accrued by a buy-sell spread may also or instead be collected separately. For example, a creation function is higher than the annulment function. For each creation transaction the surplus may be collected. For example, a second pool, e.g., a second wallet of the market maker may collect the fees. At some point, the fees in the second pool, or part thereof, may be added to the first pool. In this case, the pool becomes larger than the integral of the bonding curve suggests, which may be corrected by refitting the bonding curve.

Shown in FIG. 4A is a bonding curve as a solid line, and an updated curve as the dashed line.

Updating a bonding curve may follow the same process as selecting the initial bonding curve for the initial smart contract. In an embodiment, a parametric representation of the curve segments is chosen. For example, the parameters for a segment may be between which supply points a curve segment is valid, e.g., from 0 to s₁, from s₁ to s₂, and so on, and coefficients of an equation defining the curve. The constraints may be of three kinds.

In an embodiment, the constraints impose linear relations on the parameters. An advantage is that fitting or refitting (updating) the bonding curve comprises solving a linear set of equations.

This can be done cheaply even on chain. Even exponential terms may be fitted by linear equations assuming that the x-coordinate of the start of the segment is fixed and not fitted.

The updated bonding curve has new parameters. In FIG. 4A, these are shown as parameters 324, 325 and 326. As it happens the number of parameters is the same in this example, although the number of segments can also be changed.

Updating the bonding curve, or curves, may be initiated by calling an update procedure 223. For security reasons, the update procedure may be restricted so certain callers, e.g., governors of the contract. Alternatively, the updating may be triggered automatically, e.g., as soon as a second pool exceed a predetermined value.

There may be more than one update procedure. The above update procedure may be used to match the bonding curve to a pool amount. However, an update procedure can also be used for governing. This could be a different procedure, e.g., a second update procedure. For example, it may turn out that the bonding curve is too steep or not steep enough in some places. An update procedure can then be called to update the constraints, and to refit the curve.

In an embodiment, the smart contract implements an updating procedure for updating the bonding curve. The updating procedure may comprise fitting one or multiple curve segments to one or more constraints. The constraints may comprise the constraint that the integral over an annulment function derived from the updated second bonding curve up to the current supply size is less or equal to the amount of crypto tokens of the second type in the pool. The integral may be computed from 0 to the current supply size.

A method may comprise transferring an additional amount of crypto tokens of the second type to the pool, the integral over the updated second bonding curve being less or equal the new pool amount. This transfer may be done independently from the update, or executed in the update procedure, or verified by the update procedure.

If curve segments are used to define the bonding curve, then the updating procedure may increase or decrease the number of multiple curve segments.

FIG. 4B schematically shows an example of an embodiment of a bonding curve. The bonding curve shown in FIG. 4B is defined as a sequence of curve segments. Shown are three segments: Γ₀, Γ₁, and Γ₂. There could be two segments, or more than three segments.

The y-coordinate of the beginning point of each segment is denoted P₀, P₁ and P₂. Note that Pᵢ indicates an amount of second type tokens, even though they are shown on the x-axis in FIG. 4B. The increases of the corresponding x-coordinates are denoted Δx₀ and Δx₁. Note that the x-coordinate corresponding to P₀ is zero.

In an embodiment, the curve segments are defined by polynomials, e.g., a polynomial mapping an x-coordinate to a y-coordinate. It is convenient to write the polynomials as a Bézier curve. An advantageous choice turns out to be cubic Bézier curves. To fit a cubic Bézier curve through consecutive points Pᵢ, one may use the following formula. The values aᵢ and bᵢ are auxiliary to fit the curve.

Γᵢ(t)=(1−t)³·Pᵢ+3t(1−t)²·aᵢ+3t²(1−t)·bᵢ+t·Pᵢ₊₁

To fit the curves various conditions may be imposed. First, one may require continuous first and second derivative at the connecting points. Taking into account that the derivative is for t we may have:

$${Γ}_{i - 1}^{′} ( t = 1 ) \frac{Δ {x}_{i}}{Δ {x}_{i - 1}} = {Γ}_{i}^{′} ( t = 0 ) \\ {Γ}_{i - 1}^{″} ( t = 1 ) \frac{Δ {x}_{i}}{Δ {x}_{i - 1}} = {Γ}_{i}^{″} ( t = 0 )$$

Accordingly, we have

Γ′ᵢ(t)=3[−(1−t)²·Pᵢ+(1−3t)(1−t)·aᵢ+t(2−3t)·bᵢ+t²·Pᵢ₊₁]

and

Γ″ᵢ(t)=6[(1−t)·Pᵢ+(3t−2)·aᵢ+(1−3t)·bᵢ+t·Pᵢ₊₁]

At the connection points this means:

Γ′ᵢ(t=0)=3(−Pᵢ+aᵢ)

Γ′ᵢ(t=1)=3(−bᵢ+Pᵢ₊₁)

Γ″ᵢ(t=0)=6(Pᵢ−2aᵢ+bᵢ)

Γ″ᵢ(t=1)=6(aᵢ−2·bᵢ+Pᵢ₊₁)

For updating the curve to a new pool balance (also referred to as undergirding), we integrate the curve Γᵢ. To do so in parameter form, but retrieving the correct area, we need to care for substitution, wherein x is the current supply point. This assumes, x resides between xᵢ and xᵢ₊₁.

$$\frac{x - {x}_{i}}{{x}_{i + 1} - {x}_{i}} = t \\ \frac{dt}{dx} = \frac{1}{{x}_{i + 1} - {x}_{i}} = \frac{1}{Δ {x}_{i}} \\ \to dx = Δ {x}_{i} \cdot dt$$

Because Δxᵢ is constant during integration (no function of x), we can factor it out, hence:

$$\int {Γ}_{i} ( x ) d x = Δ {x}_{i} \cdot \int {Γ}_{i} ( t ) d t Δ {x}_{i} \cdot \int {Γ}_{i} ( t ) dt = Δ {x}_{i} \cdot \frac{1}{4} [ ( - {t}^{4} + 4 {t}^{3} - 6 {t}^{2} + 4 t ) \cdot {P}_{i} + ( 3 {t}^{4} - 8 t + 6 t ) \cdot {a}_{i} - ( 3 {t}^{4} - 4 {t}^{3} ) \cdot {b}_{i} + t 4 {P}_{i + 1} ] + C$$

For the complete curve section integral we have

$$Δ {x}_{i} \cdot {\int }_{0}^{1} {Γ}_{i} ( t ) dt = Δ {x}_{i} \cdot \frac{1}{4} ( {a}_{i} + {b}_{i} + {P}_{i + 1} + {P}_{i} )$$

and for the partial integral

$$Δ {x}_{i} \cdot {\int }_{0}^{\tilde{t}} {Γ}_{i} ( t ) d t = Δ {x}_{i} \cdot \frac{1}{4} [ ( - {\tilde{t}}^{4} + 4 {\tilde{t}}^{3} - 6 {\tilde{t}}^{2} + 4 \tilde{t} ) \cdot {P}_{i} + ( 3 {\tilde{t}}^{4} - 8 \tilde{t} + 6 \tilde{t} ) \cdot {a}_{i} - ( 3 {\tilde{t}}^{4} - 4 {\tilde{t}}^{3} ) \cdot {b}_{i} + {\tilde{t}}^{4} {P}_{i + 1} ]$$

If the current supply point resides within segment I, one solves the partial integral there. Otherwise, for the other segments below, one can use the full integral equation (0->t->1) which does not depend on x but only Δx.

Updating a bonding curve may increase or decreasing the number of multiple curve segments. Also here, the pool balance condition may be used as a requirement for the bonding curve. That is the integral over the curve up to current supply should be related, e.g., equal or a percentage, etc., to the current pool size.

Below a further details, options and embodiments are presented, in particular with regard to countermeasures against front-running attacks. Without loss of generality, we will in the following focus on the creation side, e.g., the buy side. The annulment side, e.g., the sell side, can be handled analogously.

Suppose a user posts a normal buy order τ₁ for an amount of supply s₁ at a mean price possibly limited by l₁:

τ₁^{b}: buy,s₁,l₁

Front-running this buy transaction would require an attacker to place two transactions right ahead and after τ₁, namely

τ₀^{b}: buy,s₀

τ₂^{s}: sell,s₂ with s₂=s₀

Note that if the attacker sells less than he bought, the difference |s₁−s₂| is not part of the attack. The same holds in the case of selling more than bought immediately before τ₁.

Suppose the current operation point to be at (\tilde{p}, \tilde{s}) and the buy and sell given as:

pₛ=p−σp,s

p_{b}=p+σ_{p,b}

with p being the reference price of the bonding curve model (Γ(x)) and the buy and sell spread σ_{p,b} and σ_{p,s}, respectively.

Including transaction costs c, and making use of the pool balance integral, the value to be paid for a buy and returned for a sell transaction, respectively, is given as pₛ=p−σ_{p,s} and p_{b}=p+σ_{p,b}.

Note that in this case, the fee σₚ is a function of x and therefore inside the integral. Other fee contributions, such as the dynamic fee based on trade history might be independent and be pulled out of the integral, comparable to the trading costs:

v_{τ}_{ᵢ}^{b}=∫_{\tilde{s}}^{\tilde{s}+s}^{_{b}}Γ(x)+σ_{p,b}dx+c_{τ}_{ᵢ}^{b} (73)

v_{τ}_{ᵢ}^{s}=∫_{\tilde{s}-s}_{ₛ}^{\tilde{s}}Γ(x)−σ_{p,s}dx−c_{τ}_{ᵢ}^{s} (74)

Due to a high-frequency front-running attack, the user overpays:

vₒᵥ=∫_{\tilde{s}+s}_{₀}^{\tilde{s}+s}^{₀}^{+s}^{₁}Γ(x)+σ_{p,b}dx−∫_{\tilde{s}}^{\tilde{s}+s}^{₁}Γ(x)+σ_{p,b}dx (75)

while the attacker's revenue and rate of return is:

$${v}_{{τ}_{2}^{s}} - {v}_{{τ}_{0}^{b}} = {\int }_{\tilde{s} + {s}_{1}}^{\tilde{s} + {s}_{0} + {s}_{1}} Γ ( x ) - {σ}_{p , s} d x - {c}_{{τ}_{i}^{s}} - {\int }_{\tilde{s}}^{\tilde{s} + {s}_{0}} Γ ( x ) + {σ}_{p , b} d x - {c}_{{τ}_{i}^{b}} \qquad ( 76 )$$

$$\begin{matrix} {R}_{attack} = \frac{{v}_{{τ}_{2}^{s}} - {v}_{{τ}_{0}^{b}}}{{v}_{{τ}_{0}^{b}}} & ( 77 )\end{matrix}$$

The goal of buy/sell spread σ is either to render the attacker's revenue zero or negative, e.g., the attacker pays more than he gains, or at least appropriately minimize the rate of return. In modern distributed ledger systems, transaction costs are often negligible with respect to the actual trade value, especially if the attacker is a miner who might have access to transaction execution at reduced costs. Therefore, to be on the safe side, we neglect transaction costs in the following derivations, such that the attack prevention is effective even at zero transaction costs.

Note that for a typical bonding curves the slope>0, so that the value increases with s₀. Therefore, an attacker may shift τ₁ in a region with max slope as his revenue rate would increase. A naive approach would be to introduce a constant spread function, e.g., a percentage of trade volume based fee, defined such, that shifting to the steepest region would be economically inefficient. However, when the trading point is close to the steep region, the required shift width is small but gain is large. An adequate fee to counteract these situations would make every normal user pay an unjustifiable large amount of fee when trading in less steep regions of the curve.

Inspection of the equations, especially equation 76 shows however, that naively forcing vₜ_{₂}^{s}−vₜ_{₀}^{b} [symbol] 0 would on the one hand render the attack ineffective. On the other hand it would also remove any gain from later-on selling earlier bought tokens, which however is undesirable. In an embodiment, a fee model is used which depends on local, characteristic of the curve, e.g., a region around the current supply size. The spread terms should be removing the value gain from earlier buy-related up-shift in case of later sell and earlier selling related down-shift for later buy, respectively, thereby effectively rendering buy/sell front running attacks ineffective, while allowing for value gain due to intermediary transactions of other users.

These problems may be mitigated by rendering front-running up to a certain volume inefficient. The basic insight is, that hf-front-running prevention on the one hand, and, allowing for usual trading on the other hand is possible, by introducing a reference amount (s_{fr} in the following) and preventing gains for hf-front-running all trades summing up to equal or less of this amount, while gains will be possible for any two trades bracketing a larger amount of supply. We will illustrate this in the following.

First, we define an amount of supply as reference supply for front-running prevention:

s_{fr} front running prevention amount of supply (78)

In an embodiment, the fee model may act on price as follows:

$${σ}^{gfr} = \frac{1}{2} \cdot ( \begin{matrix}Γ ( x + {s}_{fr} ) - Γ ( x ) buy \hat{=} {σ}_{p , b} \\ Γ ( x ) - Γ ( x - {s}_{fr} ) sell \hat{=} {σ}_{p , s}\end{matrix} \qquad ( 79 )$$

In another embodiment, e.g., in a symmetric approach, the fees may be as follows to apply the costs only on the sell side; with the approach for buy-side similar:

$${σ}^{gfr} = ( \begin{matrix}0 buy \hat{=} {σ}_{p , b} \\ Γ ( x ) - Γ ( x - {s}_{fr} ) sell \hat{=} {σ}_{p , s}\end{matrix} \qquad ( 80 )$$

The order of subtraction is different for buy and sell side in the symmetric case, since curve Γ(x) is strictly increasing and the definition of (73,74) we have σₚ being positive. Applying the asymmetric approach is, e.g., beneficial for a system where buying should have small fees in order to make taking part efficient, while spending the token is allowed to be more privileged compared to selling it.

The buy and sell value equations (74, 73) (neglecting transaction costs as for the reasons discussed above) can then be written as:

Symmetric case:

$${v}_{{τ}_{i}^{b}} = {\int }_{\tilde{s}}^{\tilde{s} + {s}_{b}} Γ ( x ) - \frac{1}{2} ( Γ ( x ) - Γ ( x + {s}_{fr} ) ) dx \qquad ( 81 )$$

$$= {\int }_{\tilde{s}}^{\tilde{s} + {s}_{b}} \frac{1}{2} Γ ( x ) + \frac{1}{2} Γ ( x + {s}_{fr} ) dx \qquad ( 82 )$$

$${v}_{{τ}_{i}^{s =}} {\int }_{\tilde{s} - {s}_{s}}^{\tilde{s}} Γ ( x ) - \frac{1}{2} ( Γ ( x ) - Γ ( x - {s}_{fr} ) ) dx \qquad ( 83 )$$

$$= {\int }_{\tilde{s} - {s}_{s}}^{\tilde{s}} \frac{1}{2} Γ ( x ) + \frac{1}{2} Γ ( x - {s}_{fr} ) d x \qquad ( 84 )$$

asymmetric sell-side case:

$${v}_{{τ}_{i}^{b}} = {\int }_{\tilde{s}}^{\tilde{s} + {s}_{b}} Γ ( x ) dx \qquad ( 85 )$$

$$( 86 )$$

$${v}_{{τ}_{i}^{s =}} {\int }_{\tilde{s} - {s}_{s}}^{\tilde{s}} Γ ( x ) - ( Γ ( x ) - Γ ( x - {s}_{fr} ) ) dx \qquad ( 87 )$$

$$= {\int }_{\tilde{s} - {s}_{s}}^{\tilde{s}} Γ ( x - {s}_{fr} ) d x \qquad ( 88 )$$

A general hffr-attack might be formed from an arbitrary sequence of buy and later sell (or sell and later buy in case of sell front-running) transactions summing up to a total amount sₐ:

sₐ=Σᵢ₌₀ⁿs_{a,i}

Without loss of generality, these can be summarized as illustrated in the following for the symmetric buy case:

$${v}_{{τ}_{i}^{b}} = \frac{1}{2} [ {\int }_{\tilde{s}}^{\tilde{s} + {s}_{a , 0}} Γ ( x ) = Γ ( x + {s}_{fr} ) dx + … + {\int }_{\tilde{s} + {s}_{{a}_{n - 1}}}^{\tilde{s} + {s}_{a , n}} Γ ( x ) + Γ ( x + {s}_{fr} ) dx ] = \frac{1}{2} \cdot {\int }_{\tilde{s}}^{\tilde{s} + {s}_{a}} Γ ( x ) + Γ ( x + {s}_{fr} ) dx$$

asymmetric case and sell-side is accordingly.

Therefore, the buy/sell gain when bracketing a set of transactions summing up to s₁:

sᵢ=Σᵢsᵢ (89)

by a total attack amount of sₐ is given as follows:
symmetric case:

$${v}_{{τ}_{a t t a c k}^{s}} - {v}_{{τ}_{a t t a c k}^{b}} = {\int }_{\tilde{s} + {s}_{1}}^{\tilde{s} + {s}_{1} + {s}_{a}} \frac{1}{2} Γ ( x ) + \frac{1}{2} Γ ( x - {s}_{fr} ) dx \qquad ( 90 )$$

$$- {\int }_{\tilde{s}}^{\tilde{s} + {s}_{a}} \frac{1}{2} Γ ( x ) + \frac{1}{2} Γ ( x + {s}_{fr} ) dx \qquad ( 91 )$$

$$= \frac{1}{2} \cdot {\int }_{\tilde{s} + {s}_{1}}^{\tilde{s} + {s}_{1} + {s}_{a}} Γ ( x ) - Γ ( x - {s}_{1} + {s}_{fr} ) + Γ ( x - {s}_{fr} ) - Γ ( x - {s}_{1} ) d x \qquad ( 92 )$$

asymmetric case:

v_{τ}_{_{attack}}^{s}−v_{τ}_{_{attack}}^{b}=∫_{\tilde{s}+s}_{₁}^{\tilde{s}+s}^{₁}^{+s}^{ₐ}Γ(x−s_{fr})−Γ(x−s₁)dx (93)

Independent of the attack size or (attack sub-sequence), the gain is zero for s₁=sₛᵣ and smaller zero (hence making the attack economically inefficient) for s₁<sₛᵣ. Note that these equations hold both for buy and sell attacks, respectively.

The fee for a normal user buying and later selling at the same price—marginal case of the equations (92,93) s₁→0—basically corresponds to the area gained over s_{fr} due to the slope in the trading region and scaling with the traded amount, which is what we want. We will illustrate this and provide some numbers in the following section.

FIG. 4C shows a bonding curve and illustrates, as an example, the asymmetric spread function σ^{gfr} (80) during a buy front-running attack with sₐ=s_{fr}.

FIG. 4C illustrates buy/sell in the situation for no intermediary trades in the asymmetric case. The buy would cost area 1, however the sell would provide the area when integrating with shifted integration limits by (−s_{fr}). The symmetric approach would apply the sum of half of the area to each side (integration limits once shifted by s_{fr}, once by −s_{fr}). All the other cases with bent curves, inflection points, etc., are analog.

The buy happens without extra fee and costs. The other users buy-up by s₁=s_{fr}. Afterwards, the attack sells s₂=s_{fr}. Without spread, this would provide gain corresponding to area 2, which is removed by the spread function, such that the paid-out value 1a is exactly 1 and hence the attacker has no gain:

v_{τ}_{₂}^{s}=∫_{\tilde{s}+s}_{₀}^{\tilde{s}+s}^{₀}^{+s}^{₁}Γ(x−s_{fr})dx=∫_{\tilde{s}}^{\tilde{s}+s}^{₀}Γ(x)dx (94)

FIG. 4D shows a bonding curve and illustrates buy/sell for the situation with no intermediary trades in the asymmetric example. The buy would cost area 1, however the sell would provide the area when integrating with shifted integration limits by (−s_{fr}). The symmetric approach would apply the sum of half of the area to each side (integration limits once shifted by s_{fr}, once by −s_{fr}). Other cases with other bonding curves, e.g., with bent curves, inflection points, etc., are analog.

Suppose a tokenized system of reference value v̅, reference price p̅ and token-supply s̅. Let the slope around reference supply be:

$${Γ}^{′} ( \overline{s} ) = \frac{n \cdot \overline{p}}{\overline{s}} \qquad ( 95 )$$

and the front running prevention amount of supply:

$${s}_{fr} = \frac{\overline{s}}{m} \qquad ( 96 )$$

Suppose the curvature to be negligible; this is a reasonable assumption since the fee is dominated by the slope, not the curvature. We can then estimate the function (1st two terms of the Taylor expansion around s̅) as follows:

Γ(x,s̅)=Γ(s̅)+Γr′(s̅)·(x−s̅) (97)

Insertion in the gain equations for s₁=0 and \tilde{s}=s̅ provides

$$\frac{\vert {v}_{f e e} \vert}{{v}_{t r a d}} = \frac{\vert {\int }_{\overline{s} - \frac{1}{2} {s}_{a}}^{\overline{s} + \frac{1}{2} {s}_{a}} Γ ( x - {s}_{f r} ) - Γ ( x ) dx \vert}{\overline{p} \cdot {s}_{a}}$$

$$= \frac{{s}_{s f} \cdot {Γ}^{′} ( \overline{s} ) \cdot {s}_{a}}{\overline{p} \cdot {s}_{a}}$$

$$= \frac{n}{m}$$

If we now require the total fee to be the usual 1% (buy and sell together) we have

$$m = \frac{n}{100}$$

which is means

$${s}_{fr} \approx \frac{1}{33} \overline{s}$$

for the concrete example. In fact we would use a much lower factor

$$( \approx \frac{1}{1000} )$$

which would allow for the spread fee to be

$$\approx \frac{1}{30} \% .$$

Censorship based front-running (cfr) requires collusion among a larger partition of the miners. An example would be placing a buy transaction, then blocking all sell transaction and only allow buy transactions, finally selling and hence extracting the value before processing the collected sell transactions.

Besides these buy/sell front-running attacks where the trade pair (buy & sell) is specially placed to bracket other transactions, there are also other censorship based attacks. An example would be in case colluding miners or users in relation to the colluding miners already decided to buy (or sell), the transaction could be privileged, e.g., handled with priority, e.g., by re-sorting the transactions before execution. For example, by executing sell transactions first, then the privileged buy transaction, then other buy transactions. Our dynamic buy sell spread counteracts these already such that buy and sell transactions are decoupled for an adjustable time-frame.

Below means are provided to counteract the first type of attacks (bracketing). The approach may be used to address a one-sided censorship based attack on buy and sell transactions.

Suppose there is a colluding set of miners which are able to delay buy & sell transactions. These transactions are a) not accepted into the transaction pool or b) although in the transaction pool, they are ignored, at least for a certain amount of time, before execution. Application of the amount of supply based buy sell spread σ^{gfr} (79,80) renders this kind of attack economically inefficient. However, in contrast to normal users, colluding miners could delay and re-sort transactions such that the to-be traded volume in the non-executed transaction pool grows above the amount s_{fr} for which front-running would be economically inefficient:

sₚₒₒₗ^{b}=s_{fr}+Δ_{buy} (98)

sₚₒₒₗ^{s}=s_{fr}+Δₛₑₗₗ (99)

For example, a buy side attack might delay sₚₒₒₗ^{s} as typically slope increases with s and holding the attack on a higher overall supply is more beneficial. Then placing their own buy, executing sₚₒₒₗ^{b}, and finally selling again. Thereby, a gain proportional to Δ_{buy} and Δₛₑₗₗ, respectively, can be extracted. Eqn. (76, 77) can be applied accordingly.

This kind of attack can be mitigated by selecting s_{fr}, in relation to mean trade volume and timing. As discussed above, one can choose s_{fr} such, that the related fees are acceptable. Interestingly, even though s_{fr} is independent from time based information, it can be related to a time-frame, via the traded-supply-flux. For example, one use the traded-supply-flux

$${\dot{s}}_{traded} = \frac{\partial {s}_{t r a d e d}}{\partial t} \qquad ( 100 )$$

If an attacker brackets an amount of supply larger than s_{fr}—in order to be able to extract gain, one would have to wait

$${t}_{wait} = \frac{{s}_{fr}}{{\dot{s}}_{t r a d e d}} \qquad ( 101 )$$

For comparison, in bitcoin the daily traded supply is typically around

$$\frac{1}{4} \% .$$

This includes all buy and sell transactions. In a simple approximation one could therefore assume that the daily traded supply for either buy or sell is

$$\approx \frac{1}{8} \% .$$

Although, in buy or sell bursts this may change. This is further discussed below. In an embodiment, one could therefore assume that the traded supply is typically well below

$$\frac{1}{10} \% / 24 h ,$$

in normal times. One could approximate the wait time as follows:

$${s}_{fr} = \frac{1}{2000} \overline{s} ↔ {t}_{wait} \approx 12 h \qquad ( 102 )$$

$${s}_{fr} = \frac{1}{4000} \overline{s} ↔ {t}_{wait} \approx 6 h \qquad ( 103 )$$

In an embodiment, a dynamic adaption of s_{fr}, is introduced based on the current or past s-flux (e.g., mean over last n hours). This extension counteracts a trade flux bursts might render t_{wait} too small. Thereby, s_{fr} would, e.g., be increased in steps or continuously, if the reference variable, e.g., mean flux in last n hours, becomes larger than certain values.

For example, s_{fr} may be derived from the trade volume in over a past time frame, e.g., a past number of hours. The trade volume may also be taken as the trade volume in a past number of blocks. Either can be derived from the ledger, e.g., as available to the miner. For example, s_{fr} may be a multiple of the trade volume, e.g., halve the volume in the past 6 blocks. The value can be established experimentally based on observed past trade volumes and the required resistance against attack, e.g., a resistance against a certain level of collusion among the miners, e.g., a collusion of 10%.

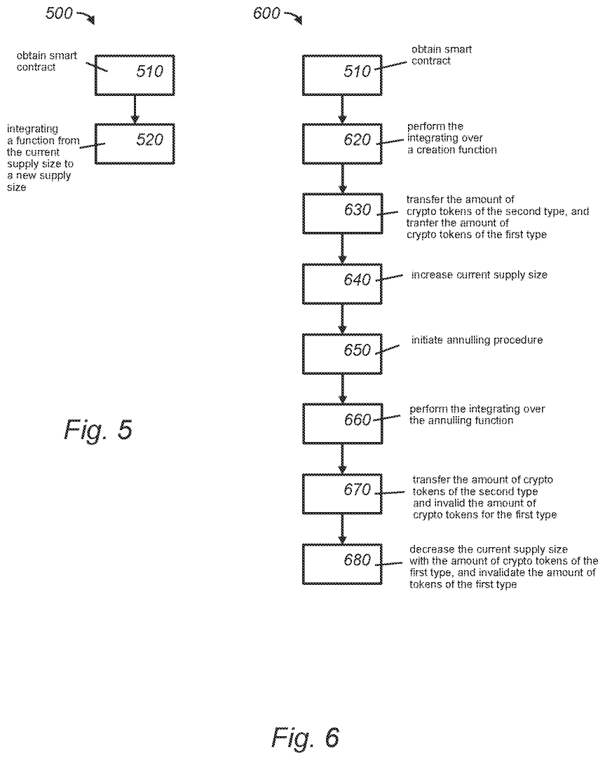

FIG. 5 schematically shows an example of an embodiment of a method 500 for maintaining crypto tokens of a first type. Method 500 is computer-implemented and comprises:
obtaining (510) a smart contract from a distributed ledger, the smart contract implementing a creation procedure for creating crypto tokens of the first type in exchange for crypto tokens of the second type and an annulling procedure for annulling crypto tokens of the first type in exchange for crypto tokens of the second type, the smart contract maintaining a current supply size indicating a current number of crypto tokens of the first type and a bonding curve defining a function. Obtaining a smart contract is optional as the creation procedure and annulment procedure may be implemented in other software as well.
the amount of crypto tokens of the second type for the exchange being computed by integrating (520) a function from the current supply size to a new supply size, the function being a sum of the bonding curve and a number of further terms, for at least one of the creation and annulling procedures the further terms including a fee term comprising a multiple of the bonding curve shifted over an amount of crypto tokens of the first type.

FIG. 6 schematically shows an example of an embodiment of a method 600 for maintaining crypto tokens of a first type. Method 600 is computer-implemented and comprises:
obtaining (510) a smart contract from a distributed ledger, the smart contract implementing a creation procedure for creating crypto tokens of the first type in exchange for crypto tokens of the second type and an annulling procedure for annulling crypto tokens of the first type in exchange for crypto tokens of the second type, the smart contract maintaining a current supply size indicating a current number of crypto tokens of the first type and a bonding curve defining a function,
in response to initiating (610) the creation procedure the method comprises—performing (620) the integrating over a creation function derived from the bonding curve and from the current supply size to the current supply plus a creation amount of crypto tokens of the first type,
   transferring (630) the amount of crypto tokens of the second type to a pool associated with the smart contract, and transferring the amount of crypto tokens of the first type, and
   increasing (640) the current supply size with the amount of crypto tokens of the first type.
in response to initiating (650) the annulling procedure the method comprises—performing (660) the integrating over an annulling function derived from the bonding curve and from the current supply size to the current supply minus an amount of crypto tokens of the first type,
   transferring (670) the amount of crypto tokens of the second type from a pool associated with the smart contract, and invalidating the amount of crypto tokens of the first type, and
   decreasing (680) the current supply size with the amount of crypto tokens of the first type, and invalidating the amount of crypto tokens of the first type.

The method 600 may further comprise transferring destroying the first type tokens, e.g., marking them invalid, transferring them to a market maker wallet, etc. Methods 500 and 600 may be combined, e.g., a method for maintaining first type token may comprise both the creation and annulment of said tokens.

For example, the methods may be computer implemented methods. For example, obtaining the smart contract from a distributed ledger may comprise retrieving a block from a distributed ledger, e.g., over a computer network, or in a local database. Executing the smart contract may be done on a microprocessor. For example, the smart contract may be written in an interpretive language, which may be executed by an interpreter, a virtual machine, or the like. Integrating a curve may comprise executing computations, e.g., inserting a current supply and a new supply in a primitive, or antiderivative, of a bonding curve, a closed form integrant. The primitive may be in closed form and may comprise multiple primitive segments. Receiving a creation or annulment request may be over a computer network. Transferring first type tokens or second type tokens may comprise writing the transfer in a block for inclusion in a block of the distributed ledger. The block may comprise a consensus mechanism, e.g., a proof of work, or proof of stake.

Many different ways of executing the methods are possible, as will be apparent to a person skilled in the art. For example, the order of the steps can be performed in the shown order, but the order of the steps can be varied or some steps may be executed in parallel. Moreover, in between steps other method steps may be inserted. The inserted steps may represent refinements of the method such as described herein, or may be unrelated to the method. For example, some steps may be executed, at least partially, in parallel. Moreover, a given step may not have finished completely before a next step is started.

Embodiments of the method may be executed using software, which comprises instructions for causing a processor system to perform method 500 and/or 600. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. Embodiments of the method may be executed using a bitstream arranged to configure programmable logic, e.g., a field-programmable gate array (FPGA), to perform the method.

It will be appreciated that the presently disclosed subject matter also extends to computer programs, particularly computer programs on or in a carrier, adapted for putting the presently disclosed subject matter into practice. The program may be in the form of source code, object code, a code intermediate source, and object code such as partially compiled form, or in any other form suitable for use in the implementation of an embodiment of the method. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the devices, units and/or parts of at least one of the systems and/or products set forth.

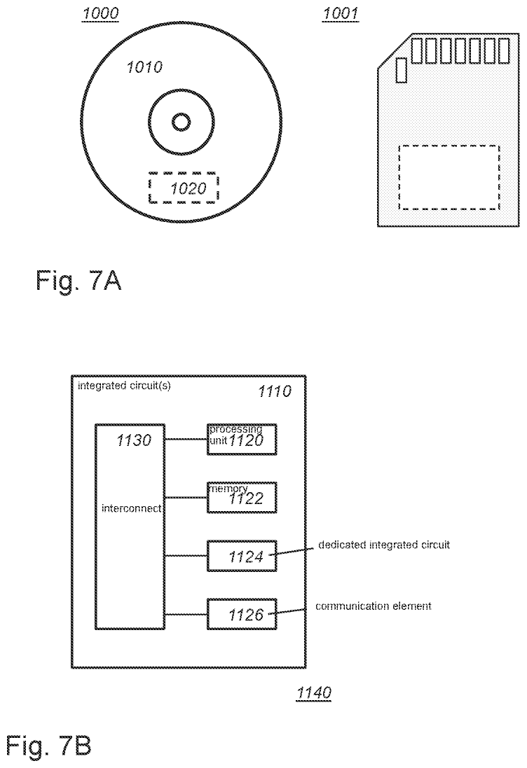

FIG. 7A shows a computer readable medium 1000 having a writable part 1010, and a computer readable medium 1001 also having a writable part. Computer readable medium 1000 is shown in the form of an optically readable medium. Computer readable medium 1001 is shown in the form of an electronic memory, in this case a memory card. Computer readable medium 1000 and 1001 may store data 1020 wherein the data may indicate instructions, which when executed by a processor system, cause a processor system to perform an embodiment of a method of maintaining a crypto token, according to an embodiment. The computer program 1020 may be embodied on the computer readable medium 1000 as physical marks or by magnetization of the computer readable medium 1000. However, any other suitable embodiment is possible as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said method.

FIG. 7B shows in a schematic representation of a processor system 1140 according to an embodiment of a device for maintaining a crypto token. The processor system comprises one or more integrated circuits 1110. The architecture of the one or more integrated circuits 1110 is schematically shown in FIG. 7B. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, processor system 1140, e.g., a device for maintaining a crypto token may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be ARM Cortex M0. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

It should be noted that the above-mentioned embodiments illustrate rather than limit the presently disclosed subject matter, and that those skilled in the art will be able to design many alternative embodiments.

Use of the verb ‘comprise’ and its conjugations does not exclude the presence of elements or steps other than those mentioned. The article ‘a’ or ‘an’ preceding an element does not exclude the presence of a plurality of such elements. Expressions such as “at least one of” when preceding a list of elements represent a selection of all or of any subset of elements from the list. For example, the expression, “at least one of A, B, and C” should be understood as including only A, only B, only C, both A and B, both A and C, both B and C, or all of A, B, and C. The presently disclosed subject matter may be implemented by hardware comprising several distinct elements, and by a suitably programmed computer. In connection of a device enumerating several parts, several of these parts may be embodied by one and the same item of hardware. The mere fact that certain measures are described in mutually different embodiments does not indicate that a combination of these measures cannot be used to advantage.

What is claimed is:

1. A computer-implemented method for maintaining crypto tokens of a first type on a distributed ledger, the method comprising the following steps:
creating crypto tokens of the first type in exchange for crypto tokens of a second type;
annulling crypto tokens of the first type in exchange for crypto tokens of the second type;
maintaining a current supply size on the distributed ledger indicating a current number of crypto tokens of the first type, a bonding curve (Γ(x)), defining a function; and
computing an amount of crypto tokens of the second type for the exchange by integrating a function from the current supply size to a new supply size, the function being a sum of the bonding curve and a number of further terms, for at least one of the creation and annulling procedures the further terms including a fee term including a multiple of the bonding curve shifted over an amount of crypto tokens of the first type (s_{fr}).

2. The method according to claim 1, further comprising:
in response to initiating the creating, performing the following steps:
performing the integrating over a creation function derived from the bonding curve and from the current supply size to the current supply plus a creation amount of crypto tokens of the first type,
transferring the amount of crypto tokens of the second type to a pool, and transferring the amount of crypto tokens of the first type, and
increasing the current supply size with the amount of crypto tokens of the first type.

3. The method according to claim 2, further comprising:
wherein
in response to initiating the annulling, performing the following steps:
performing the integrating over an annulling function derived from the bonding curve and from the current supply size to the current supply minus an amount of crypto tokens of the first type,
transferring the amount of crypto tokens of the second type from a pool, and invalidating the amount of crypto tokens of the first type, and
decreasing the current supply size with the amount of crypto tokens of the first type, and invalidating the amount of crypto tokens of the first type.

4. The method according to claim 1, further comprising:
obtaining a smart contract from the distributed ledger, the distributed ledger implementing a creation procedure for the creating of crypto tokens of the first type, and an annulment procedure for the annulment of crypto tokens of the first type, the smart contract maintaining the current supply size and defining the bonding curve.

5. The method according to claim 4, wherein the smart contract is in a block of the distributed ledger.

6. The method according to claim 3, wherein the bonding curve is defined by parameters including splines and/or line segments and/or polynomials and/or polynomial segments, and wherein integration over the bonding curve or over the creation function derived from the bonding or over the annulling function derived from the bonding curve, is computed by applying a function to the parameters.

7. The method according to claim 1, wherein:
a creation function for the creating is integrated from the current supply size to the current supply size increased with a creation amount, the creation function being a sum of the bonding curve and a fee term, and/or
an annulling function for the annulling is integrated from the current supply size to the current supply size decreased with an annulling amount, the annulling function being a remainder of the bonding curve minus a fee term.

8. The method according to claim 1, wherein the amount of crypto tokens of the second type for the exchange further adds a transaction cost for the creating and/or further subtracts a transaction cost for the annulling.

9. The method according to claim 1, wherein the fee term is proportional to the increase of the bonding curve over an interval.

10. The method according to claim 1, wherein the fee term equals a first number times a difference of the bonding curve at the current supply and the current supply, plus or minus a second number.

11. The method according to claim 1, wherein the amount of crypto tokens of the first type over which the bonding curve is shifted is a constant.

12. The method according to claim 1, further comprising:
computing the amount of crypto tokens of the first type over which the bonding curve is shifted is from the distributed ledger;
computing a volume of created and/or annulled crypto tokens in a number of most recent blocks on the distributed ledger, the amount being computed from the volume.

13. The method according to claim 1, wherein:
v_{τ}_{ᵢ}^{b}=∫_{\tilde{s}}^{\tilde{s}+s}^{_{b}}Γ(x)+σ_{p,b}dx+c_{τ}_{ᵢ}^{b}v_{τ}_{ᵢ}^{s}=∫_{\tilde{s}-s}_{ₛ}^{\tilde{s}}Γ(x)−σ_{p,s}dx−c_{τ}_{ᵢ}^{s}c_{τ}_{ᵢ}^{b}c_{τ}_{ᵢ}^{s} a creation procedure for the creating is configured to compute the amount of crypto tokens of the second type for the exchange as an the integral and/or
v_{τ}_{ᵢ}^{b}=∫_{\tilde{s}}^{\tilde{s}+s}^{_{b}}Γ(x)+σ_{p,b}dx+c_{τ}_{ᵢ}^{b}v_{τ}_{ᵢ}^{s}=∫_{\tilde{s}-s}_{ₛ}^{\tilde{s}}Γ(x)−σ_{p,s}dx−c_{τ}_{ᵢ}^{s}c_{τ}_{ᵢ}^{b}c_{τ}_{ᵢ}^{s} an annulling procedure for the annulling is configured to compute the amount of tokens of the second type for the exchange as an integral, wherein and are optional fees; and
$${v}_{{τ}_{i}^{b}} = {\int }_{\tilde{s}}^{\tilde{s} + {s}_{b}} Γ ( x ) + {σ}_{p , b} d x + {c}_{{τ}_{i}^{b}} {v}_{{τ}_{i}^{s}} = {\int }_{\tilde{s} - {s}_{s}}^{\tilde{s}} Γ ( x ) - {σ}_{p s} dx - {c}_{{τ}_{i}^{s}} {c}_{{τ}_{i}^{b}} {c}_{{τ}_{i}^{s}}$$
$$wherein$$
$${σ}^{gfr} = \frac{1}{2} \cdot ( \begin{matrix}Γ ( x + {s}_{fr} ) - Γ ( x ) & buy \hat{=} {σ}_{p , b} \\ Γ ( x ) - Γ ( x - {s}_{fr} ) & sell \hat{=} {σ}_{p , s}\end{matrix} or$$
$${σ}^{gfr} = ( \begin{matrix}0 & buy \hat{=} {σ}_{p , b} \\ Γ ( x ) - Γ ( x - {s}_{fr} ) & sell \hat{=} {σ}_{p , s}\end{matrix} .$$

14. The method according to claim 1, wherein a creation function for the creating or an annulling function for the annulling is derived from a bonding curve as a linear combination of one or more of the bonding curve and/or a shifted bonding curve and/or an constant.

15. A server device for maintaining crypto tokens of a first type, the server device comprising:
a communication interface configure to obtain blocks from a distributed ledger;
a processor system configured to execute a creation procedure for creating crypto tokens of the first type in exchange for crypto tokens of a second type and an annulling procedure for annulling crypto tokens of the first type in exchange for crypto tokens of the second type, the processor system maintaining a current supply size indicating a current number of crypto tokens of the first type and defining a bonding curve defining a function,
wherein the amount of crypto tokens of the second type for the exchange being computed by integrating a function from the current supply size to a new supply size, the function being a sum of the bonding curve and a number of further terms, for at least one of the creation and annulling procedures, the further terms including a fee term including a multiple of the bonding curve shifted over an amount of crypto tokens of the first type.

16. A client device for maintaining crypto tokens of a first type, the client device comprising:
a communication interface configured to send a request for creating or annulling an amount of crypto tokens of the first type; and
a processor system configured to:
maintain a wallet with crypto tokens of a second type, and to transfer or receive an amount of crypto tokens of the second type to or from a pool,
maintain a wallet with crypto tokens of the first type, and to transfer or receive an amount of crypto tokens of the first type,
wherein
an amount of crypto tokens of the second type for an exchange for crypto tokens of the first type being computed by integrating a function from the current supply size to a new supply size, the function being a sum of the bonding curve and a number of further terms, for at least one of the creation and annulling procedures the further terms including a fee term including a multiple of the bonding curve shifted over an amount of crypto tokens of the first type.

17. A non-transitory computer readable medium on which are stored data representing instructions for maintaining crypto tokens of a first type on a distributed ledger, the instructions, when executed by a computer, causing the computer to perform the following steps:
creating crypto tokens of the first type in exchange for crypto tokens of a second type;
annulling crypto tokens of the first type in exchange for crypto tokens of the second type;
maintaining a current supply size on the distributed ledger indicating a current number of crypto tokens of the first type, a bonding curve defining a function; and
computing an amount of crypto tokens of the second type for the exchange by integrating a function from the current supply size to a new supply size, the function being a sum of the bonding curve and a number of further terms, for at least one of the creation and annulling procedures the further terms including a fee term including a multiple of the bonding curve shifted over an amount of crypto tokens of the first type.
